(19) United States
(12) Patent Application Publication
(10) Pub. No.: US 2003/0052117 A1
(43) Pub. Date: Mar. 20, 2003

(54) Food warmer and preserver

(76) Inventor: Jorge Iniestra Hernandez, Anaheim, CA (US)

Correspondence Address: JORGE INIESTRA HERNANDEZ, 2203 W. Huntington Ave., Anaheim, CA, 92801, US

(21) Appl. No.: 10/225,657

(22) Filed: Aug. 22, 2002

Related U.S. Application Data
(60) Provisional application No. 60/314,833, filed on Aug. 24, 2001.

(51) Int. Cl. F27D 11/00

(52) U.S. Cl. 219/438; 219/439

(57) ABSTRACT

The present invention relates to a new and improved storage food recipient with carrying handle, for placing within tortillas, pizzas, pancakes or similar kind of food, after heating in a microwave, keeping them warm for extended time, and is comprised of two containers adapted to each other, an outer container and an inner container, wherein the inner container's walls and bottom are of a double thickness with an internal cavity between each wall thickness for holding either heated water, or a cooled equivalent fluid to retain cold condition for food preservation. The outer container contains a sealed cover that, besides retaining the temperature, will contain a solar heating panel with heating elements for reheating and preserving the temperature of the products contained therein.

### BACKGROUND OF THE INVENTION

There is a definite need for a compact, economical, practical means for retaining the heating the tortillas, pizza, pancakes, and other fast foods, after they are heated and ready to serve, or to rewarm them when conventional heating means are not available.

Presently, when tortillas for example are prepared, they are usually heated up and then various meats, cheese, lettuce and other food products are placed on top of flat tortilla and then it is folded or rolled around these fillings. To do this it is very desirable to heat the tortilla up, and then, when it is filled completely with the inserted food products added, the tortilla is served warm. There are many occasions when it is desirable to prepare the tortillas ahead of the scheduled meal time, or to prepare them for a picnic or a delayed party. For these periods, the tortillas are prepared warm or hot and it has become very difficult to reheat them sometimes or to keep them warm or hot until it is time to serve and eat them. Eating cold tortillas is not as enjoyable as eating a hot tortilla, or one that is prepared just before eating. In addition, there are many times when it is desirable to prepare them in advance for taking on a trip or for feeding children on the trip while driving. At these times, there is no convenient way to reheat them or cook the fillings that are placed in them. Identical problems exist regarding other types of similar fast food.

It has been found that there is a dire need to find a convenient way to prepare them in advance and then retain the heat in them for several hours or so, after the cooking and preparation. In addition, commercial houses or restaurants have a distinct need for preparing them in advance and then delivering them “hot” to their customers.

It has been found that most present heat retainers are difficult to package in the warm or heated condition without extreme cost in complex blankets and portable heat ovens or closures.

It is known that some end user food preservering systems utilize blankets to retain heat in products that have to be delivered hot, or use elaborate drawers or ovens in restaurants to preheat and hold heat in precooked or prepared foods to serve at a later time. However, such known systems are either cumbersome to handle, assemble and use, or require special cabinets or ovens to accomplish their objective.

Some existing Patents with related titles do not apply to this invention.

For example, U.S. Pat. No. 4,723,674 (Nunes) provides a liquid food container that has a cover that is capable of floating on the surface of the fluid contents of the container and is comprised of a semi-rigid planar central portion with an upturned flexible annular lip attached to the periphery of the central portion and provides a method for allowing the air to pass out from under the lid. The invention is basically a cover for preserving fluids with a lip seal that is attached to a lid for insertion in a fluid container and only presents a method for sealing the lid and bleeding air out of the sealed portion beneath the lid. This configuration does not apply to the present invention.

U.S. Pat. No. 5,704,485 (Cautereels et al) provides a food container with cooling pack installed internally within the container. A tray is provided for supporting the food above or near the cooling pack. The configuration does not apply to the present invention.

U.S. Pat. No. 5,839,652 (Ben-Hahn) provides a microwave box with collapsible sides and base to enable the box to be assembled for storing food products. The configuration does not apply to the present inveniton.

U.S. Pat. No. 4,671,079 (Petrantoni) provides a chambered chest for storage of food articles to be cooled or heated. The chest holds blocks of ice for cooling. The configuration does not apply to the present invention.

U.S. Pat. No. 6,248,257 B1 (Bell et al) provides a portable heat source that may be used to warm food, beverages, or other supplies. The heater is activated by addition of water on an aqueous solution. The device provides heat from a chemical reaction with various acids and salts contained therein and as a result of the reaction, heat is produced to warm the foods. The configuration does not apply to the present invention.

U.S. Pat. No. 5,174,452 (Wang) Provides a transparent plastic container with side handles and partitions within that hold food and utensils for picnics, that can be microwaved for heating, prior to use. The configuration does not apply to the present invention.

U.S. Pat. No. 339,353 (Wiedemann) provides a closure for a container which is lowered into the container to reduce airspace therein. The closure to be lowered into the container contains two slots to allow air to circulate down into the food product. The configuration does not apply to the present invention.

U.S. Pat. No. Des. 286,729 (Tzifkansky et al) provides a food box with hinged lid. The configuration does not apply to the present invention.

U.S. Pat. No. Des. 272,971 (Talton) provides a food container with a close fitting lid and a method of sealing the box with round corners that mate with the lid. The configuration does not apply to the present invention.

Thus, there exists a need for a new and improved, more efficient container device that is easy to fill with hot or cold water that does not contact the food products, but still has a means to retain the desired temperature in the inner container that holds the food products to be preserved.

### BRIEF SUMMARY OF THE INVENTION

This invention provides a means for placing one or more tortillas, pizzas or other similar kind of food products in a container, after heating in a microwave, and provides a means for keeping them warm or hot for an extended period of time.

The invention is comprised of two containers adapted to each other: an inner container whose walls are of a double thickness to form an internal cavity for retention of heated water, or filled with cold water, or equivalent fluid, then in turn be heated with the tortillas, pizza or similar food products already inserted within the enclosed doubled walled food space and after the inner container and tortillas are heated up, the inner container is inserted into the outer container that is made of insulated material to retain heat.

The inner container is fabricated from a heat transmittable material that conducts the heat to the tortillas, or similar type of food, as the water within is heated up. This container is provided with a water refill opening and an indicator marker for filling the container and preventing over filling and spillage when the water is heated up and its capacity expands. The refill opening contains a captured plug that closes out the fill opening after water refill.

The outer container is an enclosure with a snugly fitting cover to hold and retain the heat internally in the inner container. In addition with the warm or hot container fully captured within the insulated outer enclosure, this complete package can now be easily carried without fear of burnt hands or setting the entire assembly down on to some surface that might be scarred by the heat. The outer enclosure contains a sealed cover that fully retains the internal heat. The two containers are designed and manufactured to fit closely in each other, can be round, square or any shape or size, and provides for good packaging and easy carrying should delivery be required.

Another unique feature of this food warmer and preserver is that if it is used for foods that require cold temperatures for their preservation, then the inner container with captured water or equivalent liquid can be frozen and the unit can now retain the cold condition for food preservation.

The object of this invention encompasses several embodiments that can be utilized for heating or cooling different foods. In one of the possible embodiments of the invention, and as a method for heating up the internal container, should normal heating facilities not be available, there is a sealed cover that, besides retaining the heat, will contain heating elements and a solar heating panel.

### DRAWING REFERENCE NUMERAL WORKSHEET

11—Container Assemblage complete

12—Outer Container

13—Cover

14—Handle

15—Groove for cover locking

16—Solar Panel

17—Inner Container

18—Drain Release Fitting

19—Insulated Material

20—Heat Transmittable Material

21—Water Level Indicator

22—Water Refill

23—Handle Pivot

24—Pads

25—Heat Elements

26—Solar Panel Cover

27—Cover Lower Step

28—End Contact to Solar Panel

29—Space for Water or Equivalent Fluid

30—Water or Equivalent Fluid

31—Food Area

32—Wire bent to permit rotation of cover

33—Handle Shaped for carrying

34—Cover Retention Clip

35—Cover rotation locking latch

36—Engagement Pin

37—Corrugated Surface

### BRIEF DESCRIPTION OF THE SEVERAL VIEWS OF THE DRAWING

A preferred embodiment of the invention is presented with respect to the accompanying drawings, wherein:

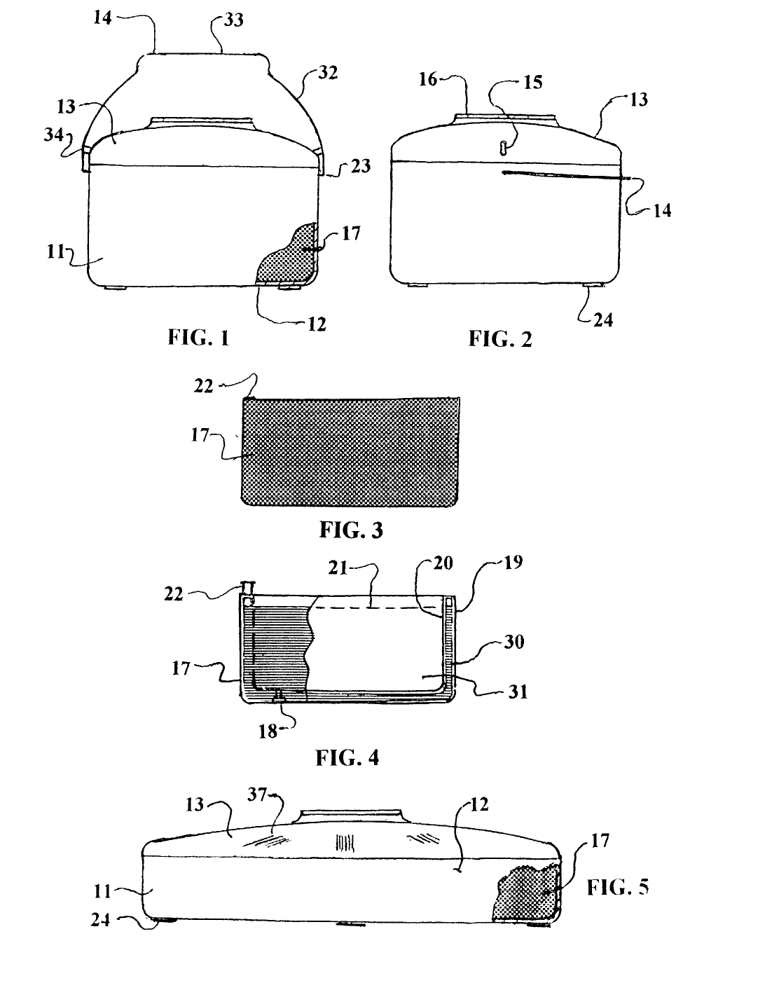

FIG. 1—is a side exterior view of the present invention.

FIG. 2—is an exterior view showing the handle rotated to the cover release position.

FIG. 3—is an exterior view of the inner container.

FIG. 4—shows a cross section view of the inner container.

FIG. 5—shows the exterior view of a large shallow container.

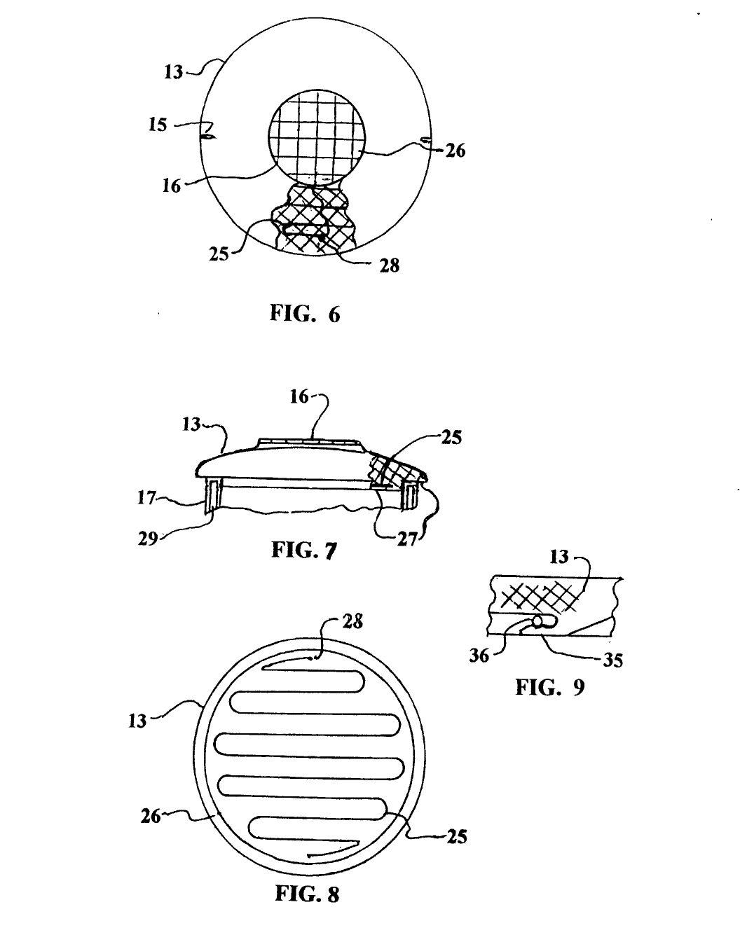

FIG. 6—shows the top view of the cover assembly.

FIG. 7—shows a cross section view of the cover assembly.

FIG. 8—shows the arrangement of the molded-in cover heater element.

FIG. 9—shows the latch engagement after cover has been rotated.

### DETAILED DESCRIPTION OF THE INVENTION

Referring now to the figures, like elements are represented by like numerals throughout the several views.

The illustrated preferred embodiment of the invention is shown in FIG. 1 and is identified as a complete assemblage by 11 and is comprised of an outer container 12 that holds an inner container 17 that is sized to easily slip in the said outer container 11. The said assemblage contains a cover 13 and a handle 14 for carrying the unit and for ease of use by the user. The said assemblage 11 is used as a food container and its shape can be either round, square or rectangular, and as such the said inner container 17 that actually holds the food products is of equal shape as the outer container but sized small enough to slide inside the said outer container 12. The said outer container is moulded in one piece from a fireproof plastic and is not limited in size or shape. For foods such as tortillas they would have a deep cavity, and for food such as pizza they would be of a much larger diameter or shape and be considerably shallower. FIG. 5 illustrates such a container shallow in depth and large in diameter. The said outer container provides an attachment hole 180 degrees apart near the upper edge of the said container for installation of the wire or equivalent material bent handle 14. This said handle pivots around these two attachments holes and permits the said handle to be centered over the said container assemblage 11 for carrying the food contained in the inner container. This said handle 14 is shaped with a straight section 33 at its center for ease of handling and carrying of the said container. In addition, the said wire handle 14 contains a cover spring retention clip 34 welded on each side of the said handle to provide a means for locking the handle in the upper carrying position and provide a means for applying external pressure on the said container cover 13 when the handle 14 is rotated up, over and engages the cover groove 15 to seal the cover as it bears down on the top rim of the said inner and outer containers. The said outer container 12 is provided with felt or rubber pads 24 on its lower bottom surface to prevent the heated container from marking up any surface it is placed upon. The number of these said pads 24 that it would contain would depend on the size of the said outer container. A small container could have one, two or three pads, while a larger container would need four or more, as required, to provide sufficient protection from scalding or marking the surface it may be placed upon. FIG. 2 shows these said pads 24 and shows how the said handle 14 can be rotated down to provide access to the said cover 13 for insertion of food, later removal and access to the foods it contains.

FIG. 1 and FIG. 5 show two embodiments of the invention having similar assemblage components. Each said assemblage 11 contains an inner container 17 for holding the food products 31 as shown in FIG. 4. The said inner container provides for a means of heating or cooling of the products it contains. This is accomplished by having this said container fabricated with provisions for installing and retaining hot or cold water or equivalent liquid in the walls of the container. The heat or cold temperature of this contained fluid is then transmitted to the food in the container. The said container 17 is constructed of an inner wall 20 and an outer wall 19 that provides a capture space or cavity 29 for insertion of the warm, hot or cold fluid 30 as needed for heating or cooling of the food 31 contained in the said inner container 17. The said fluid 30 is poured into the said container 17 through a fill opening along the top of the said container after filling the fluid cavity 29 to a level as shown by an indicator 21 on the side of the said container. The fill opening is sealed closed by a water refill close-out assembly 22. Since the said inner wall of the said container is comprised of a translucent heat transmittable material, the said side wall indicator 21 is marked on the inside wall, and the fill quantity of water or other fluid 30 can be easily monitored during the fill operation. To provide for replacement of the water or other fluid 30, replenishment of a different temperature water or for system cleanout, the said container contains a drain release fitting 18 installed flush on the bottom surface of said container. After emptying the water cavity 29 this said fitting is closed and seals the said water cavity.

The process of installing water or equivalent fluid in said container cavity provides the invention with the capability of transmitting heat or cold as deemed necessary by conduction for preservation of the internal stored food products in the said inner container 17. The outer wall 19 of the said container is comprised of an insulated material for retention of heat or cold temperature within the said water cavity 29.

An optional embodiment of this said inner food container is to have this said outer cavity 29 filled with a solid inert insulated material similar to that material utilized for the said outer wall 19. In this embodiment the food products within the said inner container would be preheated and heat would be maintained by a solar panel 16 in the said cover 13. Therefore, in this embodiment the water fill fitting 22, the drain fitting 18 and the water level indicator 21 would not be required.

To capture and retain the heat or cold in the said inner container, the said assemblage 11 is comprised of a said cover 13 that contains a said solar panel 16 for transfer of heat from an external heat source, such as the sun or an external heat lamp, to the products contained within the said inner food container. In order to conduct this heat to the food products, the said solar panel 16 is molded into the said cover and is wired through interface wiring contacts 28 to a heat element 25 molded into the lower surface of the said cover. The said heat element is positioned in the said cover in a serpentine arrangement to maximum heat transfer to the food products by convection from the said cover to the said inner container. FIG. 6 provides an illustration of the said solar panel 16 and FIG. 8 illustrates the interface wiring contacts 28 and the general arrangement of the said heat element 25. FIG. 7 shows a cross section through the said cover 13 and shows how the said cover contains a stepped lower surface 26 that bears on the top perimeter surface of the said outer container and bears on the top surface of the said inner container for sealing to prevent escapement of heat.

The said cover's lower stepped surface projects downward 27 and fits within the said inner container envelope, and provides a means for positioning and centering the said cover on the said assemblage, and provides for retention of heat, and prevents spillage of products in the container. The said cover contains two small indent grooves 15 in the outer surface to permit retention of the said handle 14 in the extended carry position, and provides a means for retention of the said cover in the enclosed covered position. This retention of the handle 14 is achieved by the use of a cover spring retention clip 34 that engages the indent groove for cover locking 15 in the said cover.

For those heat warmer and preserver containers that are large for storing and heating pizzas and related large sized foods, as shown in FIG. 5, the said cover cannot be conveniently locked in place with the wire carry handle. Thus, for this said specific embodiment of said container, the said cover contains a small series of molded in latches 35 that engage projecting pins 36 from the inside of the said inner wall of the food container. FIG. 9 shows the said cover's latch 35 engaged with the said pin 36 in a locked location.

Rotation of the said cover in a clockwise direction engages each said latch with one of the said projecting pins. Counterclock rotation of the said cover disengages the said latches with the said pins. The top surface of the said cover 13 contains some molded in corrugations 37 to make it easy for rotation of the said cover in either direction.

Further objectives and advantages of the present invention will become apparent and reside in the details of the construction and operation. The specification should not be construed as limiting the scope of the invention but as illustration of some of the embodiments of the invention.

I claim:

1. In combination:
a food container, round, square or rectangular in shape, comprised of an inner and an outer container, a cover, and a handle for carrying the assembly,
the said inner container is for heat retention of preheated food products,
the said outer container holds and captures the said inner container and holds heat within the complete assemblage,
the said cover provides a means for retention of heat in the said inner container,
the said handle provides a means for retention of the cover and for carrying the complete said assemblage,
the said cover provides a means for replenishing lost heat to the products in the said inner container,
the said outer container provides a means for locating and positioning of the said cover,
the said outer container contains one, three, four or more or less felt, rubber or equivalent pads on its lower outer bottom surface to prevent the heated container from marking up any surface it is placed upon,
the said handle is shaped to provide a convenient means for grasping the handle,
the said handle is additionally shaped to permit its rotation over and around the said cover in operation of releasing the cover for installation and removal of food products,
the said handle contains a retention clip that engages a groove in the said cover and retains and locks the handle in the up position and also applies an external downward pressure on the cover for retention of heat in the said assemblage,
the vertical height of the said container is not limited and can be shallow or deep as needed,

2. an invention that is comprised of an inner container, as claimed in claim 1, and comprised of:
an inner and an outer wall providing an internal cavity for retention and holding heated water or alternate fluid for internal heating of the contained food products,
a water fill plug that provides a means for filling the inner container with preheated water prior to inserting food products into the said container,
a water level indicator for aid in pouring heated water into the inner container water cavity,
a drain plug in the bottom of the said inner container to provide a means for removal of the said captured warm or cold water in the container's wall,
a smooth inner wall of the container to permit ease of cleaning and prevent any possibility of contamination in the area where the food products are placed,
the said inner wall of the said water cavity is comprised of a heat transmittable material for heating the contained food products,
the outer wall of the said water cavity is comprised of an insulated material for the containment of the heat within the container;
an optional wall and bottom for the said inner container that is molded solid from a heat resistant plastic material that acts as a barrier to inhibit heat loss from the internal preheated products it contains,

3. the said cover of claim 1 is comprised of a molded shape envelope that matches the said outer container,
the said cover contains a stepped lower surface that bears on the top perimeter surface of the said outer container and bears on the top surface of the said inner container; for sealing to prevent escapement of heat,
the said cover's lower surface projects downward and fits within the said inner container and provides a means for retention of heat and prevents spillage of products in the container,
the said cover contains a solar panel molded into its upper surface for heating products within the said inner container,
the said solar panel transmits heat to a heat element molded into the said cover through interface wiring contacts,
the said heat element is shapped to provide maximum heat transfer to the contained food products in the said inner container,
the said cover contains two small indent cavities in the outer surface to permit retention of the said handle in the extended carry position and provide a means for retention of the said cover in the enclosed covered position,
the said cover contains a series of cover rotation latches that engage projecting pins on the innner wall of the container and latch when the cover is rotated for engagement,
the said cover contains a latch and engagement pin for retention and locking the cover to the outer container,
the said cover can be rotated clockwise for installation and counterclockwise for removal.
